(19) United States
(12) Patent Application Publication
(10) Pub. No.: US 2026/0118680 A1
(43) Pub. Date: Apr. 30, 2026

(54) OPTICAL WAVEGUIDE WITH SPLIT APERTURE

(71) Applicant: LUMUS LTD., NESS ZIONA (IL)

(72) Inventor: Yochay DANZIGER, Kfar Vradim (IL)

(73) Assignee: LUMUS LTD., NESS ZIONA (IL)

(21) Appl. No.: 19/149,925

(22) PCT Filed: Mar. 29, 2024
(86) PCT No.: PCT/IB2024/053081

§ 371 Date: Jul. 22, 2025

Related U.S. Application Data
(60) Provisional application No. 63/456,009, filed on Mar. 31, 2023.

(51) Int. Cl. G02B 27/01

(52) U.S. Cl. CPC G02B 27/0172

(57) ABSTRACT

The waveguide includes a pair of major surfaces that are parallel to one another and an aperture configured to receive a plurality of beams. The aperture includes a pair of sub-apertures that are co-planar and offset in one dimension. The waveguide also includes a first set of facets that are configured to receive the beams from the aperture and at least partially reflect the beams towards a second set of facets. The second set of facets are configured to receive the beams from the first set of facets and at least partially reflect the beams out of the lightguide. The sub-apertures are offset in the one dimension by an offset distance that corresponds to a projected distance along the one dimension that the beams travel while the beams traverse one trip between the major surfaces between the first set of facets and the second set of facets.

### BACKGROUND

Unless otherwise indicated herein, the materials described in this section are not prior art to the claims in this application and are not admitted to be prior art by inclusion in this section.

The present disclosure relates in general to systems and methods of presenting information to a user, more particularly, to optical systems and near eye displays for presenting information to a user.

Wearable optical devices, such as near eye displays or smart glasses, are often limited in their ability to fully illuminate a cross-section of the waveguides used therein. If the cross-sections are not fully illuminated, the images may be non-uniform (e.g., have banding or other unwanted artifacts). Illumination becomes increasingly difficult with multiple-axis expansion waveguides, where a beam is expanded in two dimensions. Even when such waveguides are fed with conjugate beams (e.g., double beams), only a single beam may be transmitted by each facet in a first set of facets towards a second set of facets. The single beam propagation between facet sets can lead to inadequate illumination. What is needed is a solution that addresses these issues, and others.

### SUMMARY

An optical waveguide with a split aperture is described herein. The waveguide includes a pair of major surfaces that are parallel to one another. The waveguide also includes an aperture comprising a pair of sub-apertures that are aligned along a first axis, aligned along a second axis, and offset along a third axis. Each sub-aperture is configured to receive one or more beams. The waveguide further includes a first set of facets that are formed between the major surfaces, parallel to one another, equally spaced from one another, and configured to receive the beams from the aperture and at least partially reflect the beams towards a second set of facets. The waveguide also includes the second set of facets that are formed between the major surfaces, parallel to one another, equally spaced from one another, and configured to receive the beams from the first set of facets and at least partially reflect the beams out of the lightguide. The apertures are offset by an offset distance that corresponds to a projected distance along the third axis that the beams travel while the beams traverse one trip between the major surfaces after being reflected by the first set of facets.

An apparatus is also described herein. The apparatus includes a display system configured to produce a pair of one or more beams (e.g., a pair of conjugate beams or a pair of non-conjugate beams). The apparatus also includes the optical waveguide discussed above.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 illustrates an example of a system including an optical waveguide with a split aperture, in accordance with various examples of the present disclosure.

FIG. 2 illustrates an example of an optical waveguide including a split aperture, in accordance with various examples of the present disclosure.

FIG. 3 illustrates an example beam propagation with an optical waveguide including a split aperture, in accordance with various examples of the present disclosure.

FIG. 4 illustrates three example apertures within an optical waveguide with a split aperture, in accordance with various examples of the present disclosure.

FIG. 5 illustrates example partial reflections of beams by first facets of an optical waveguide with a split aperture.

FIG. 6 further illustrates the example partial reflections of FIG. 5 when the aperture includes two adjacent sub-apertures.

FIG. 7 further illustrates the example partial reflections of FIG. 5 when the aperture includes separated sub-apertures.

FIG. 8 illustrates an example of an optical waveguide with virtual sub-apertures, in accordance with various examples of the present disclosure.

FIG. 9 illustrates an example of an optical waveguide with a split aperture for non-conjugate beams, in accordance with various examples of the present disclosure.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

To be described in more detail below, a wearable device, such as a near eye display and/or smart glasses, can be implemented by a system and method described in accordance with the present disclosure. The system can efficiently provide high quality optical information to a user in various applications.

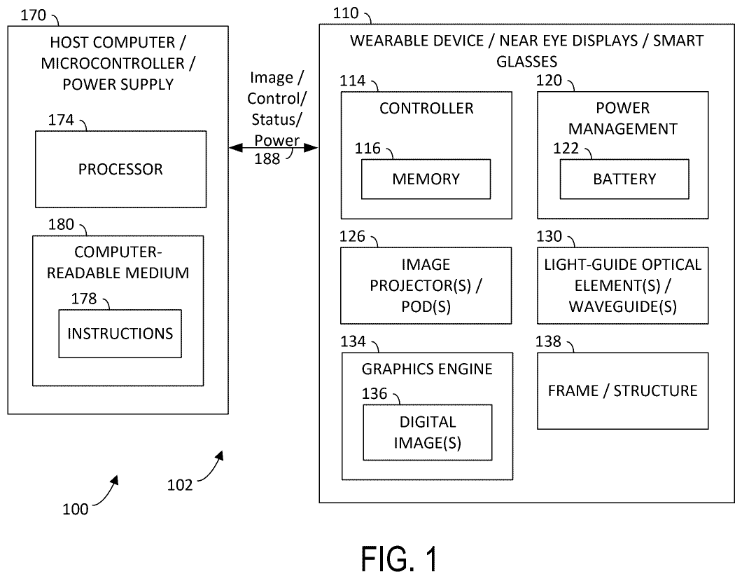

FIG. 1 illustrates a block diagram of an example optical system 100 containing an optical waveguide with a split aperture. Optical system 100 may include two or more devices or components. Optical system 100 may be implemented generally as a hybrid system including various electronic, optical, and electro-optical elements. An optical device 102 may include one or more elements from optical system 100. To be described in more detail below, an optical system 100 may include a wearable device 110, such as one or more near eye displays or smart glasses, which may be worn on or about the head of a user to convey optical information to one or more eyes of a user.

Wearable device 110 may include a controller 114 with a memory 116 where controller 114 may be configured to send and receive electrical signals to various other elements in optical system 100, to execute program instructions stored in memory 116 in order to process and provide information, to operate wearable device 110, and to interact with other systems outside wearable device 110, for example. Controller 114 may include a microcontroller, a processor, various discrete components, programmable logic devices, and/or various interface circuits that may access memory 116 which may be removable, replaceable, programmable, and reprogrammable to update instructions to controller 114.

Wearable device 110 may also include a power management module 120 having a battery 122, where power management module 120 may be configured to charge, discharge, and monitor power usage for battery 122. Various elements of wearable device 110 may receive power from battery 122, including controller 114, one or more image projector(s) 126 (e.g., a projecting optical device, or POD), and graphics engine 134 having one or more digital images 136, for example.

Wearable device 110 may also include one or more image projectors 126, each configured to produce a collimated image beam based on a digital image 136. The collimated image beam may be an illuminated representation of the digital image having an image field which is a two-dimensional representation of the digital image based on either a single graphical image (e.g., a static image) or a sequence of graphical images (e.g., a moving image). The collimated image beam may be collimated to infinity.

Wearable device 110 may also include one or more light-guide optical elements 130 (e.g., LOEs, also denoted as waveguides WGs, waveguide with split aperture) comprising transparent materials configured to receive and propagate light, where light may enter into and exit from various external and internal surfaces of light-guide optical element 130. For example, the transparent material comprising light-guide optical element 130 may include optical glass or other suitable material that is transformed into complex optical structures using a process that may include coating, stacking, slicing, polishing, and shaping the transparent materials. The process may include the addition of partially reflective or fully reflective materials such as mirror coatings, for example. Similarly, the process may also include the addition of partially opaque or fully opaque materials such as light covers to block light, for example.

Wearable device 110 may also include one or more graphics engines 134 coupled to the one or more image projectors 126 and light-guide optical elements 130. Graphics engine 134 may be configured to directly operate image projector 126 under the direction of the controller 114. For example, graphics engine 134 may provide graphics processing for the digital image before projection of an illuminated representation of the digital image by image projector 126.

Wearable device 110 may also include a frame 138 (e.g., a structure) for supporting and retaining one or more elements in wearable device 110. For example, frame 138 may support and retain a first image projector 126a in position next to a first light-guide optical element 130a. Similarly, frame 138 may support and retain a second image projector 126b in position next to a second light-guide optical element 130b. In this manner, frame 138 may support and retain one or two image projector 126 and light-guide optical element 130 pairs on or about the head of a user. References are made herein regarding the orientation of various elements relative to each other. Such references may also include reference to various elements of wearable device 110 when supported by frame 138 or in reference to a three-dimensional (3D) reference (e.g., X, Y, Z axes), as described in the relevant drawing figure.

Optical system 100 may also include a host computer 170 that may include a processor 174 configured to read and execute operations based on instructions 178 stored in a computer-readable medium 180. Instructions 178 may include at least some instructions provided to controller 114 and stored in memory 116. Host computer 170 may communicate with one or more elements of wearable device 110 over a signal and power bus 188. In this manner, host computer 170 may provide power to charge battery 122, provide instructions to and receive status from controller 114 and various other elements of wearable device 110, and to provide digital image data to graphics engine 134.

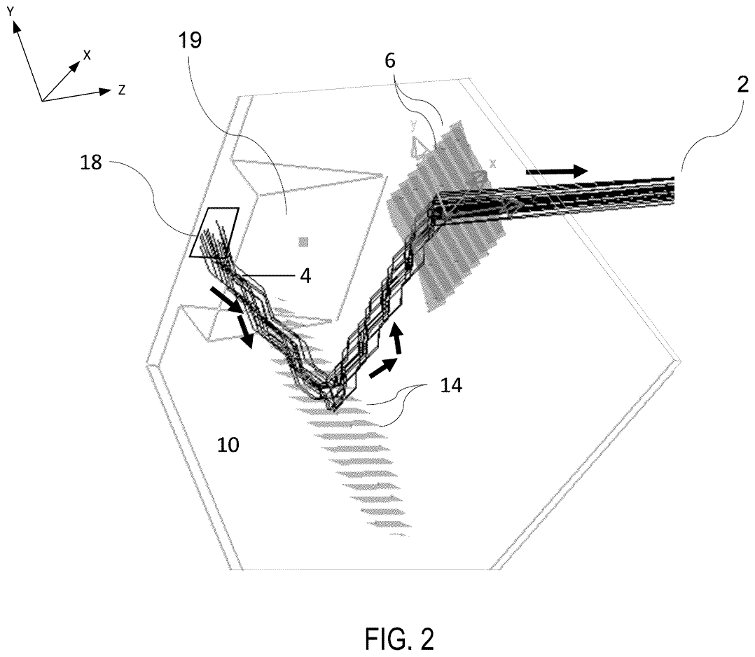

FIG. 2 illustrates an example of an optical waveguide 10 (hereinafter waveguide 10) with a split aperture. The waveguide 10 may be one of the light-guide optical elements 130. A three-dimensional cartesian coordinate system (e.g., X, Y, and Z axes) is illustrated. The same coordinate system is used throughout for clarity. The coordinate system used may vary (e.g., axes and directions) without departing from the scope of this disclosure.

The projector 126 (not shown) produces image light beams 4 (hereinafter beams) that enter the waveguide 10 through an aperture 18. The aperture 18 may be located on a coupling-in prism 19. The axes are set such that the aperture 18 is within a plane that is parallel to the X-Z plane.

The beams 4 propagate via total internal reflection (TIR) between parallel major surfaces of the waveguide 10 toward a first set of facets 14. The first set of facets 14 may be oblique to external surfaces of the waveguide 10 and are configured to at least partially reflect the beams 4 towards a second set of facets 6. The beams 4 propagate via TIR between the parallel major surfaces between the first set of facets 14 and the second set of facets 6. The second set of facets 6 may also be oblique to the external surfaces of the waveguide 10 and are configured to at least partially reflect the beams 4 out of the waveguide 10 towards an eye box 2. In order to generate a uniform image, a cross-section of the waveguide 10 may be fully illuminated as discussed below.

The beams 4 generally propagate parallel to the Y axis from the aperture 18 towards the first set of facets 14 (they may reflect via TIR in the Y-Z plane but generally progress in a direction parallel to the Y axis). When they are reflected by the first set of facets 14, the beams 4 generally propagate parallel to the X axis (they may reflect via TIR in the X-Z plane but generally progress in a direction parallel to the X axis). When they are reflected by the second set of facets 6, the beams 4 generally propagate parallel to the Z direction (e.g., out of the waveguide 10 towards the eye box 2). The propagation directions may differ angularly from the axes without departing from the scope of this disclosure. For example, the beams 4 may propagate in any direction towards the first set of facets 14 and in any direction towards the second set of facets 6 after being reflected by the first set of facets 14.

As used herein, each set or group of facets may include a plurality of planar, mutually-parallel and partially reflecting optical elements (e.g., facets) spaced apart from each other. Hence, each of the facets of a respective group may be parallel to each other and disposed at the same oblique angle. Also, the facets described herein may include an angularly selective coating and may be controlled to have multiple states (e.g., on/off) or to change a level of reflectivity and/or transmissivity of each facet or a cooperative collection of facets in a structure. A final facet (e.g., a terminal facet, furthest down facet in the first set of facets 14 and furthest right facet in the second set of facets 6) in a structure may be fully mirrored (e.g., not partially mirrored) to reflect any remaining illumination that may have passed through the prior facets in the structure. Alternatively, each facet may have the same partial reflectivity for consistency, reduced complexity, and simpler construction. Conversely, each group of facets may have multiple partial reflectivities (e.g., one or more of the facets may have different partial reflectivities) and/or the final facet may be partially mirrored.

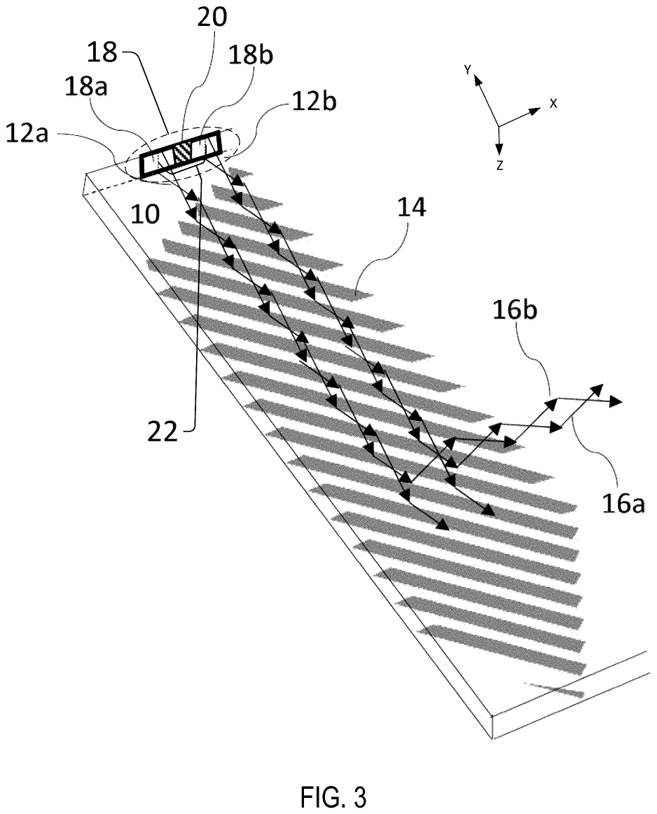

FIG. 3 illustrates an example beam propagation within the waveguide 10. The aperture 18 contains two sub-apertures (e.g., sub-aperture 18a and sub-aperture 18b) that are aligned relative to the Y and Z axes but offset relative to the X axis. In other words, the sub-apertures 18a and 18b are coplanar and parallel to the X-Z plane but have a gap between them relative to the X axis. The sub-apertures 18a and 18b are offset such that center lines (e.g., the dotted lines parallel to the Z axis) of the sub-apertures 18a and 18b are spaced apart by an offset distance 22. In some implementations, an absorber material 20 may be disposed on the aperture 18 between the sub-apertures 18a and 18b (e.g., within the gap between the sub-apertures 18a and 18b). In other implementations, the sub-apertures 18a and 18b may be adjacent to each other without the absorber material 20 disposed therebetween. The offset distance 22 and whether the absorber material 20 may be used is discussed further below.

Each sub-aperture is configured to receive a beam (e.g., beam 12a for sub-aperture 18a and beam 12b for sub-aperture 18b). Beams 12a and 12b may be in the centers of the sub-apertures 18a and 18b, respectively, and at centers of the projected field. The aperture 18 may be within the waveguide 10 (e.g., the waveguide 10 may extend past the aperture 18), or the aperture 18 may be on an end of the waveguide 10. Beams 12a and 12b may have an incident angle less than a critical angle of the waveguide 10 and may propagate via TIR parallel to the Y axis towards, and partially through (via partial reflectivity), the first set of facets 14. In some implementations, the beams 12a and 12b may propagate in a direction that is not parallel to the Y axis. Beams 12a and 12b may be double or conjugate beams (e.g., contain anti-phase reflection beams) and may be parallel or collimated. Thus, the aperture 18 (and the first set of facets 14) may be configured to receive co-propagating double beams that are spaced apart by the offset distance 22.

When the first set of facets 14 are oblique to the external surfaces of the waveguide (e.g., non-perpendicular to the parallel major surfaces) and the beams 12a and 12b are double beams, each facet of the first set of facets 14 will reflect one of the double beams (the other will pass through). The reflected beams (e.g., beams 16a and 16b) become a double beam due to the spacing of the first set of facets 14, as discussed further below.

The waveguide 10 is configured to have the offset distance 22 match a projected distance along the major surfaces that the beams 16a and 16b travel between the parallel major surfaces. Beams 16a and 16b may propagate via TIR parallel to the X axis towards and partially through the second set of facets 6 (not shown). In some implementations, the beams 16a and 16b may propagate in a direction that is not parallel to the X axis. Because beams 16a and 16b form a double beam, the waveguide 10 may be fully illuminated.

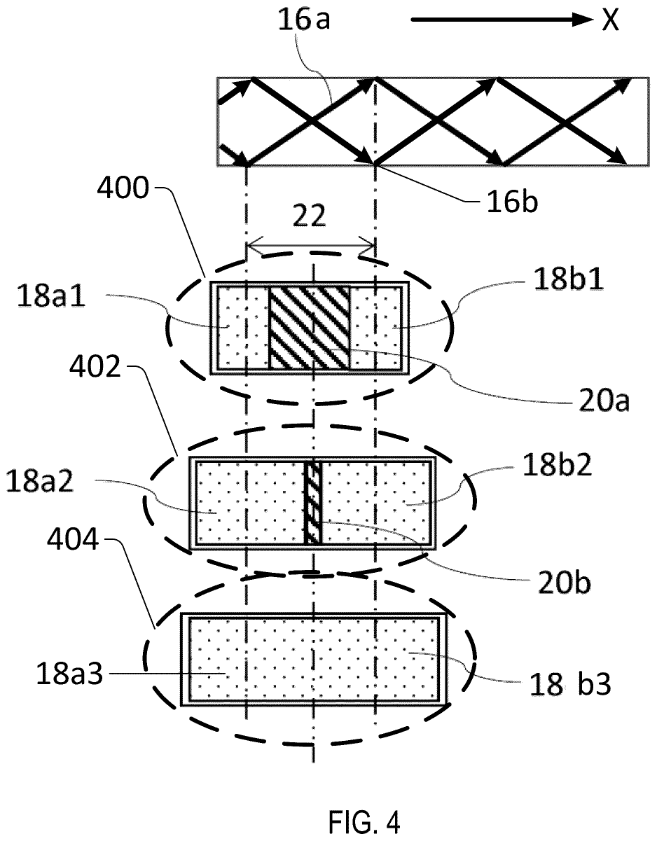

FIG. 4 illustrates three example of the aperture 18 (e.g. example 400, example 402, and example 404) that may be used within the waveguide 10. A cross-view of the beams 16a and 16b is shown for reference. The offset distance 22 between centerlines of the sub-apertures 18a and 18b corresponds to a projected distance along the major surfaces that one of the beams 16a or 16b makes between the parallel major surfaces (e.g., a half-reflection cycle). In other words, the offset distance 22 corresponds to a single “bounce” distance along the X axis (if the beams 16a and 16b propagate parallel to the X axis).

In each of examples 400-404, the offset distance 22 is the same. In the example 400, the sub-apertures 18a1 and 18b1 have relatively thin widths and a wide absorber material 20a. Such implementations may enable the projector 126 to be small in width (e.g., along the X axis). In the example 402, the sub-apertures 18a2 and 18b2 have relatively wider widths with a thinner absorber material 20b. In the example 404, the sub-apertures 18a3 and 18b3 have a maximum width available for the given offset distance 22. In other words, the sub-apertures 18a3 and 18b3 are adjacent to one another with no absorber material therebetween. The sub-apertures 18a3 and 18b3 may, together, emulate a single aperture. Such implementations may enable higher projected power; however, the projector 126 may be larger in width (e.g., along the X axis). The maximum aperture width is generally twice the offset distance 22 (e.g., example 404).

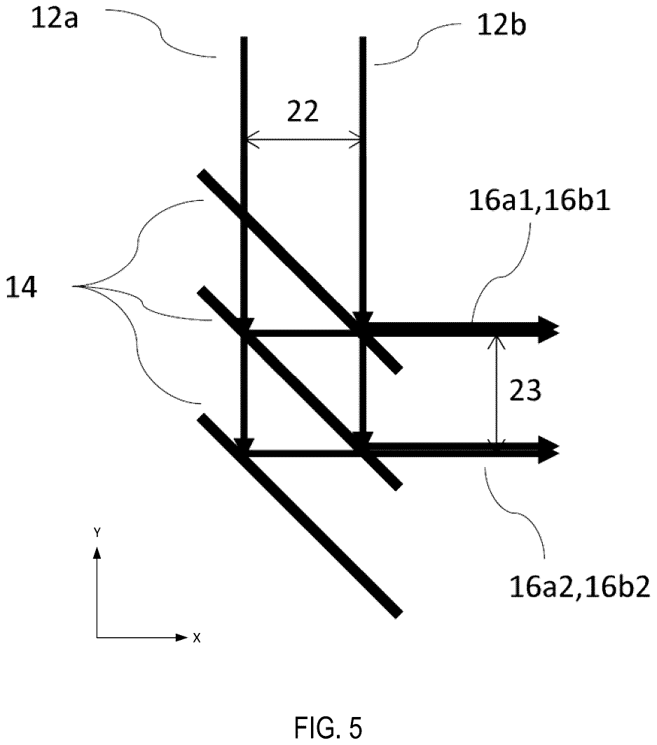

FIG. 5 illustrates example partial reflections of beams by the first set of facets 14 of the waveguide 10. As discussed above beams 12a and 12b are received by the first set of facets 14 from the aperture 18 (not shown) via TIR. The beams 12a and 12b are separated by the offset distance 22. The first set of facets 14 partially reflect the beams 12a and 12b to create beams 16a1 and 16b1 and beams 16a2 and 16b2. The spacing between the first set of facets 14 is such that beams 16a1 and 16b1 overlap in the X-Y plane (e.g., they produce a double beam towards the second set of facets 6) and that beams 16a2 and 16b2 overlap in the X-Y plane (e.g., they produce another double beam towards the second set of facets 6). In other words, beams originating from one aperture have “partners” conjugated from beams originating from the other aperture to produce a uniform image. Without that one-to-one correspondence, there may be no uniqueness (and the image may not be uniform).

Adjacent double or overlapping beams (e.g., 16a1, 16b1 and 16a2, 16b2) are separated by a separation distance 23. In other words, two adjacent facets of the first set of facets 14 creates beams 16a1 and 16b1, and a next two facets that are adjacent create beams 16a2 and 16b2. The separation distance 23 may be the same or different from the offset distance 22 depending upon various angles of the waveguide 10 and a spacing of the first set of facets 14.

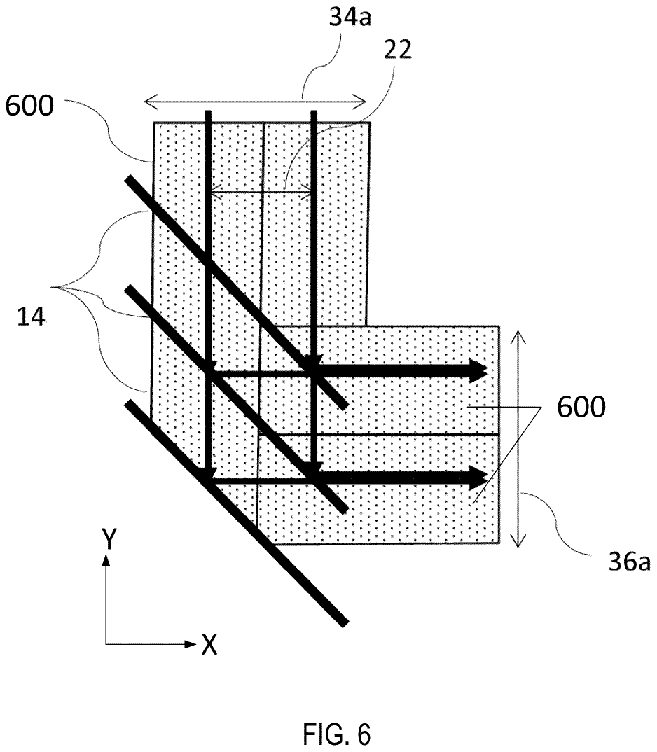

FIG. 6 illustrates the example partial reflections of FIG. 5 when the aperture 18 includes two adjacent sub-apertures (e.g., similar to example 404). The beams are still offset by the offset distance 22, but are shown with corresponding illumination bands 600. Because the sub-apertures are adjacent (e.g., with no absorber material 20 between them), and because of the spacing of the first set of facets 14, the reflections from the first set of facets 14 are fully illuminated (illustrated by adjacent illumination bands 600).

The spacing of the first set of facets 14 may be set such that the separation distance 23 will be equal to the offset distance 22. If the spacing is too large, there may be a gap between the illumination bands 600. Conversely, if the spacing is too small, there may be an overlap in the illumination bands 600. In both cases, illumination may not be uniform.

A width of the beams 34a may correspond to a width of the aperture 18. A width of the beams 36a may be the same as the width of the beams 34a for uniform illumination. The widths may vary, however, without departing from the scope of this disclosure.

While the waveguide 10 may be fully illuminated in the illustrated example, the aperture 18 may be prohibitively wide (e.g., width of the beams 34a may require a prohibitively large projector). Thus, there may be a tradeoff between illumination and size of the aperture 18 and/or the projector 126.

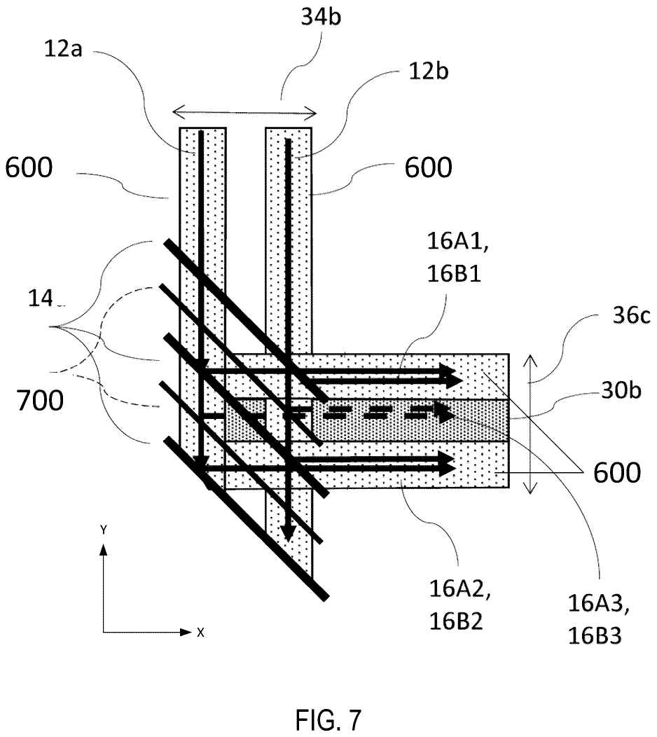

FIG. 7 illustrates the example partial reflections of FIG. 5 when the aperture 18 includes separated sub-apertures (e.g., similar to examples 400 and 402). The offset distance 22 between beams 12a and 12b is similar to that of FIG. 6, but the width of the beams 34b may be less than the width of the beams 34a due to thinner sub-aperture widths. Because the sub-apertures are separated (e.g., non-adjacent), the width of the beams 34b is not fully illuminated. Because the width of the beams 34b is not fully illuminated, the reflections therefrom may not be fully illuminated (illustrated by the area 30b between the illumination bands 600. A width of the beams 36c may be the same as the width of the beams 34b for uniform illumination. The widths may vary, however, without departing from the scope of this disclosure.

To fully illuminate the waveguide 10, a third set of facets 700 may be added. The third set of facets 700 may be parallel to the first set of facets 14 and may be interleaved with the first set of facets 14. In other words, each facet of the first set of facets 14 may be equidistant from each facet of the third set of facets 700. As illustrated, the third set of facets 700 illuminates the area 30b. The third set of facets 700 may allow for full illumination when the aperture 18 includes an absorber material. It should be noted that the aperture 18 in such implementations is thinner than the aperture 18 of the example shown in FIG. 7 (e.g., 34b is thinner/less than 34a given the same offset distance 22). Design constraints may dictate an overall width of the aperture 18 which influences the sub-aperture width (assuming the offset distance 22 is fixed) and thus, a width of the absorber material 20. Accordingly, a smaller aperture 18, may benefit from the third set of facets 700.

Again, there may be a tradeoff between full illumination and size of the aperture 18 and/or the projector 126. Accordingly, the absorber material 20 may be any width including zero (e.g., adjacent sub-apertures).

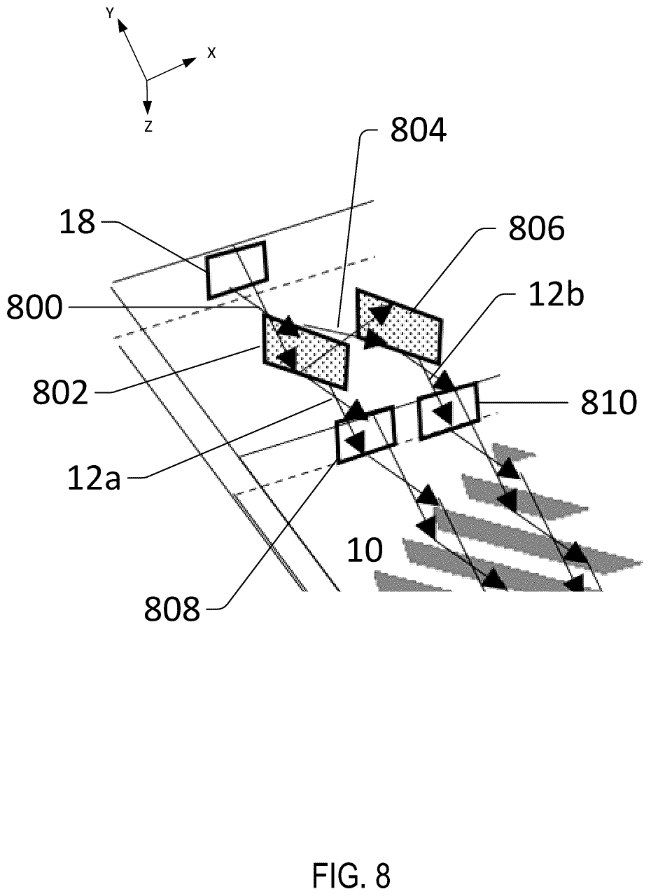

FIG. 8 illustrates an example of the waveguide 10 with virtual sub-apertures. The effect of the illustrated example is the same as that of FIG. 3. That is, the first set of facets 14 receive beams 12a and 12b that are parallel and spaced apart the offset distance 22. To do so, an incident beam 800 is split into beams 12a and 12b. The split may occur in the waveguide 10 or in a separate waveguide that is attached to the waveguide 10.

The incident beam 800 enters the waveguide 10 or the separate waveguide though the aperture 18. In the illustrated example, the aperture 18 is not split (e.g., it functions as a single aperture). The incident beam 800 may have an incident angle less than a critical angle of the waveguide 10 or other waveguide and may be a double or a conjugate beam (as shown). The incident beam 800 may also be a single beam without departing from the scope of this disclosure. The incident beam 800 may propagate via TIR parallel to the Y axis towards, and partially through (via partial reflectivity), a beam splitter 802. In some implementations, the incident beam 800 may propagate in a direction that is not parallel to the Y axis.

The beam splitter 802 passes a portion of the incident beam 800 as the beam 12a and reflects a portion of the incident beam 800 as a beam 804 towards a reflector 806 (e.g., along the X axis). In some implementations, the beam 804 may propagate in a direction that is not parallel to the X axis. The reflector 806 reflects the beam 804 as the beam 12b.

Between the beam splitter 802 and the first set of facets 14 is a first virtual aperture 808. Between the reflector 806 and the first set of facets 14 is a second virtual aperture 810. The first virtual aperture 808 and the second virtual aperture 810 may be separated similar to the sub-apertures 18a and 18b. The beam splitter 802 and the reflector 806 may be configured such that the first virtual aperture 808 and the second virtual aperture 810 are adjacent.

The first virtual aperture 808 and the second virtual aperture 810 may be more abstract or more tangible. For example, when the beam splitter 802 and the reflector 806 are within the other waveguide, the first virtual aperture 808 and the second virtual aperture 810 may be on a transition between the other waveguide and the waveguide 10. If, however, the beam splitter 802 and the reflector 806 are within the waveguide 10, the first virtual aperture 808 and the second virtual aperture 810 may be conceptual since there is no transition between the beam splitter 802 and the reflector 806 and the first set of facets 14.

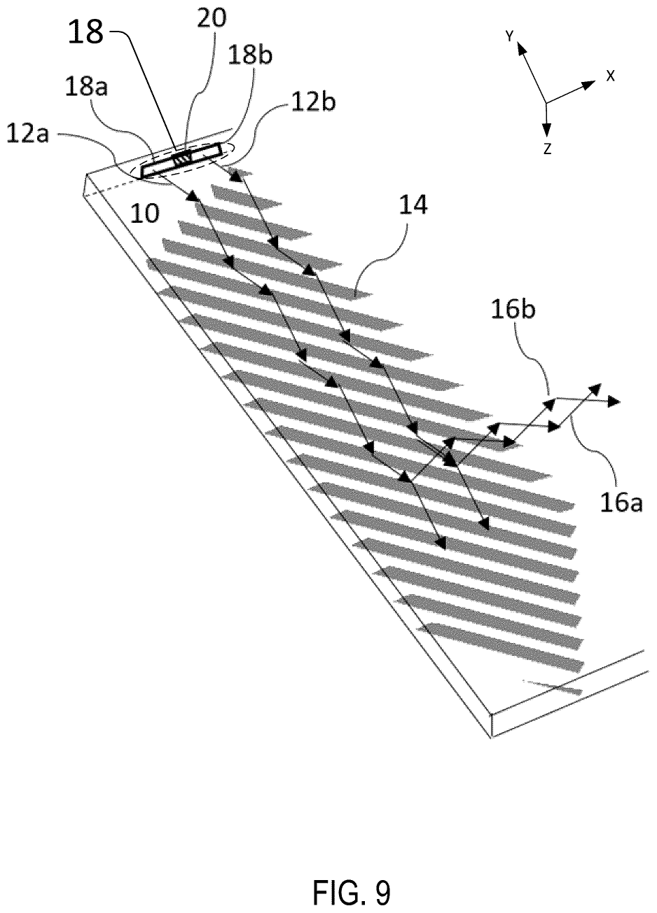

FIG. 9 illustrates an example of the waveguide 10 configured for beams 12a and 12b to be non-conjugate (single) parallel beams. The aperture 18 may be configured similarly to the examples in FIGS. 3 and 4 but with a reduced height (e.g., along the Z axis). This is because the single beams may not require the full height of the waveguide. In some implementations, however, the aperture 18 may be a full height (e.g., extending between the parallel major surfaces). Either way, the projector 126 producing non-conjugate beams may be smaller than the projector 126 producing conjugate beams. Also, because the beams are single beams, each of the first set of facets 14 may only reflect one of beams 12a and 12b.

Different from the examples above, the first set of facets 14 may be perpendicular to the parallel major surfaces. In combination with the spacing of the sub-apertures 18a and 18b and the spacing of the first set of facets 14 generating beams 16a and 16b that have opposite TIR phase, the perpendicular first set of facets 14 may cause the waveguide 10 to be fully illuminated when beams 12a and 12b are single beams.

It should also be noted that the structures of FIG. 8 may also be applied to the illustrated example. For example, a beam splitter and reflector may be used to produce virtual apertures instead of the split aperture shown.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, the terms up, upper, down, lower, above, below, left, right, forward, rearward, and the like are intended to be understood in the context of the representations described and illustrated above so that a wearable device may have such an orientation in reference to the frame or to various elements as supported by the frame or as illustrated in the drawing figures.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The various embodiments were chosen and described in order to best explain the principles of the invention and the practical application, and to enable others of ordinary skill in the art to understand the invention for various embodiments with various modifications as are suited to the particular use contemplated.

### Examples

Example 1: A waveguide comprising: a pair of major surfaces that are parallel to one another; an aperture comprising a pair of sub-apertures that are aligned along a first axis, aligned along a second axis, and offset along a third axis, the sub-apertures configured to receive respective beams; and a first set of facets and a second set of facets, wherein the first set of facets is formed between the major surfaces, includes facets that are parallel to one another, and is configured to receive the beams from the aperture and at least partially reflect the beams towards the second set of facets, and wherein the second set of facets is formed between the major surfaces, includes facets that are parallel to one another, and is configured to at least partially reflect the beams reflected by the first set of facets out of the waveguide, wherein the sub-apertures are offset by an offset distance that corresponds to a projected distance along the major surfaces that the beams may travel while the beams traverse one trip between the major surfaces after being reflected by the first set of facets.

Example 2: The waveguide according to example 1, wherein the facets of the first set of facets and the second set of facets are oblique to external surfaces of the waveguide.

Example 3: The waveguide according to example 1, wherein the facets of the first set of facets are perpendicular to the major surfaces.

Example 4: The waveguide according to any preceding example, wherein the beams propagate to and through the first set of facets along the first axis.

Example 5: The waveguide according to any preceding example, wherein the beams propagate to and through the second set of facets along.

Example 6: The waveguide according to any preceding example, wherein a distance between two facets of the first set of facets is configured such that a first beam from a first sub-aperture of the sub-apertures at least partially reflected by a first facet of the two facets and a second beam from a second sub-aperture of the sub-apertures at least partially reflected by a second facet of the two facets overlap.

Example 7: The waveguide according to example 6, wherein the overlapping beams partially reflected by the two facets and another pair of overlapping beams partially reflected by a next adjacent pair of facets of the first set of facets are separated by a separation distance.

Example 8: The waveguide according to example 7, wherein the separation distance is equal to the offset distance.

Example 9: The waveguide according to example 7, wherein the separation distance is different than the offset distance.

Example 10: The waveguide according to any preceding example, wherein the apertures are adjacent to one another.

Example 11: The waveguide according to any preceding example, wherein the sub-apertures have a gap between them along the third axis.

Example 12: The waveguide according to example 11, further comprising an absorber disposed in the gap.

Example 13: The waveguide according to example 11 or 12, wherein: a distance between two facets of the first set of facets is configured such that a first beam from a first sub-aperture of the sub-apertures at least partially reflected by a first facet of the two facets and a second beam from a second sub-aperture of the sub-apertures at least partially reflected by a second facet of the two facets overlap; and the waveguide further comprises a third set of facets parallel to the first set of facets and interleaved between the first set of facets.

Example 14: An apparatus comprising: a projector configured to produce a pair of parallel beams; a waveguide comprising: a pair of major surfaces that are parallel to one another; an aperture comprising a pair of sub-apertures that are aligned along a first axis, aligned along a second axis, and offset along a third axis, the sub-apertures configured to receive respective beams of the pair of parallel beams; and a first set of facets and a second set of facets, wherein the first set of facets is formed between the major surfaces, includes facets that are parallel to one another, and is configured to receive the beams from the aperture and at least partially reflect the beams towards the second set of facets, and wherein the second set of facets is formed between the major surfaces, includes facets that are parallel to one another, and is configured to receive the beams from the first set of facets and at least partially reflect the beams out of the waveguide, wherein the sub-apertures are offset by an offset distance that corresponds to a projected distance along the major surfaces that the beams may travel while the beams traverse one trip between the major surfaces after being reflected by the first set of facets.

Example 15: The apparatus of example 14, wherein the pair of parallel beams comprise a pair of parallel conjugate beams.

Example 16: The apparatus of example 15, wherein the facets of the first set of facets are oblique to external surfaces of the waveguide.

Example 17: The apparatus of example 14, wherein the pair of parallel beams comprise a pair of non-conjugate beams.

Example 18: The apparatus of example 17, wherein the facets of the first set of facets are perpendicular to the major surfaces.

Example 19: The apparatus of example 17 or 18, wherein the aperture has a height along the second axis that is less than a distance between the major surfaces.

Example 20: A waveguide comprising: a pair of major surfaces that are parallel to one another; an aperture configured to receive a beam; a beam splitter configured to receive the beam from the aperture, pass a portion of the beam towards a first set of facets as a first beam, and reflect another portion of the beam towards a reflector; the reflector configured to receive the other portion of the beam from the beam splitter; and reflect the other portion of the beam towards the first set of facets as a second beam; and the first set of facets and a second set of facets, wherein the first set of facets is formed between the major surfaces, includes facets that are parallel to one another, and is configured to receive the first beam from the beam splitter and the second beam from the reflector and at least partially reflect the first beam as reflected first beams toward the second set of facets and the second beam as reflected second beams towards the second set of facets, and wherein the second set of facets is formed between the major surfaces, includes facets that are parallel to one another, and is configured to receive the reflected first beams and the reflected second beams from the first set of facets and at least partially reflect the reflected first beams and the reflected second beams out of the waveguide, wherein the beam splitter and the reflector are configured such that the second beam is parallel to the first beam and offset from the first beam at an offset distance that corresponds to a projected distance along the major surfaces that the reflected first beam and the reflected second beam may travel while the reflected first beam and the reflected second beam traverse one trip between the major surfaces.

Example 21: The waveguide according to example 20, wherein the facets of the first set of facets and the second set of facets are oblique to external surfaces of the waveguide.

Example 22: The waveguide according to example 20, wherein the facets of the first set of facets are perpendicular to the major surfaces.

Example 23: The waveguide of any of examples 20-22, wherein: the beam splitter and the reflector are disposed within a first waveguide; the first set of facets and the second set of facets are disposed within a second waveguide; and the first waveguide is attached to the second waveguide

Example 24: The waveguide according to any of examples 20-23, wherein the first set of facets is configured such that reflected first beams from facets of the first set of facets and reflected second beams from adjacent facets of the first set of facets overlap to create overlapping reflected beams.

Example 25: The waveguide according to example 24, wherein the overlapping reflected beams are separated by the offset distance.

Example 26: The waveguide according to any of examples 20-25, wherein the offset distance is equal to a width of the aperture along the axis.

Example 27: An apparatus comprising: a projector configured to produce a beam; a waveguide comprising: a pair of major surfaces that are parallel to one another; an aperture configured to receive the beam; a beam splitter configured to receive the beam from the aperture, pass a portion of the beam towards a first set of facets as a first beam, and reflect another portion of the beam towards a reflector; the reflector configured to receive the other portion of the beam from the beam splitter; and reflect the other portion of the beam towards the first set of facets as a second beam; and the first set of facets and a second set of facets, wherein the first set of facets is formed between the major surfaces, includes facets that are parallel to one another, and is configured to receive the first beam from the beam splitter and the second beam from the reflector and at least partially reflect the first beam as reflected first beams toward the second set of facets and the second beam as reflected second beams towards the second set of facets, and wherein the second set of facets is formed between the major surfaces, includes facets that are parallel to one another, and is configured to receive the reflected first beams and the reflected second beams from the first set of facets and at least partially reflect the reflected first beams and the reflected second beams out of the waveguide, wherein the beam splitter and the reflector are configured such that the second beam is parallel to the first beam and offset from the first beam at an offset distance that corresponds to a projected distance along the major surfaces that the reflected first beam and the reflected second beam may travel while the reflected first beam and the reflected second beam traverse one trip between the major surfaces.

Example 28: The apparatus of example 27, wherein the beam comprises a conjugate beam.

Example 29: The apparatus of example 28, wherein the facets of the first set of facets are oblique to external surfaces of the waveguide.

Example 30: The apparatus of example 27, wherein the beam comprises a non-conjugate beam.

Example 31: The apparatus of example 30, wherein the facets of the first set of facets are perpendicular to the major surfaces.

Example 32: The apparatus of example 30 or 31, wherein the aperture has a height along another axis that is less than a distance between the major surfaces.

1-13. (canceled)

14. An apparatus comprising:
a projector configured to produce a pair of parallel beams;
a waveguide comprising:
a pair of major surfaces that are parallel to one another;
an aperture comprising a pair of sub-apertures that are aligned along a first axis, aligned along a second axis, and offset along a third axis, the sub-apertures configured to receive respective beams of the pair of parallel beams; and
a first set of facets and a second set of facets,
wherein the first set of facets is formed between the major surfaces, includes facets that are parallel to one another, and is configured to receive the beams from the aperture and at least partially reflect the beams towards the second set of facets, and
wherein the second set of facets is formed between the major surfaces, includes facets that are parallel to one another, and is configured to receive the beams from the first set of facets and at least partially reflect the beams out of the waveguide,
wherein the sub-apertures are offset by an offset distance that corresponds to a projected distance along the major surfaces that the beams may travel while the beams traverse one trip between the major surfaces after being reflected by the first set of facets.

15. The apparatus of claim 14, wherein the pair of parallel beams comprise a pair of parallel conjugate beams.

16. The apparatus of claim 15, wherein the facets of the first set of facets are oblique to external surfaces of the waveguide.

17. The apparatus of claim 14, wherein the pair of parallel beams comprise a pair of non-conjugate beams.

18. The apparatus of claim 17, wherein the facets of the first set of facets are perpendicular to the major surfaces.

19. The apparatus of claim 17, wherein the aperture has a height along the second axis that is less than a distance between the major surfaces.

20-26. (canceled)

27. An apparatus comprising:
a projector configured to produce a beam;
a waveguide comprising:
a pair of major surfaces that are parallel to one another;
an aperture configured to receive the beam;
a beam splitter configured to receive the beam from the aperture, pass a portion of the beam towards a first set of facets as a first beam, and reflect another portion of the beam towards a reflector;
the reflector configured to receive the other portion of the beam from the beam splitter; and reflect the other portion of the beam towards the first set of facets as a second beam; and
the first set of facets and a second set of facets,
wherein the first set of facets is formed between the major surfaces, includes facets that are parallel to one another, and is configured to receive the first beam from the beam splitter and the second beam from the reflector and at least partially reflect the first beam as reflected first beams toward the second set of facets and the second beam as reflected second beams towards the second set of facets, and
wherein the second set of facets is formed between the major surfaces, includes facets that are parallel to one another, and is configured to receive the reflected first beams and the reflected second beams from the first set of facets and at least partially reflect the reflected first beams and the reflected second beams out of the waveguide,
wherein the beam splitter and the reflector are configured such that the second beam is parallel to the first beam and offset from the first beam at an offset distance that corresponds to a projected distance along the major surfaces that the reflected first beam and the reflected second beam may travel while the reflected first beam and the reflected second beam traverse one trip between the major surfaces.

28. The apparatus of claim 27, wherein the beam comprises a conjugate beam.

29. The apparatus of claim 28, wherein the facets of the first set of facets are oblique to external surfaces of the waveguide.

30. The apparatus of claim 27, wherein the beam comprises a non-conjugate beam.

31. The apparatus of claim 30, wherein the facets of the first set of facets are perpendicular to the major surfaces.

32. The apparatus of claim 30 wherein the aperture has a height along another axis that is less than a distance between the major surfaces.

33. The apparatus of claim 31, wherein the aperture has a height along another axis that is less than a distance between the major surfaces.

34. The apparatus of claim 18, wherein the aperture has a height along the second axis that is less than a distance between the major surfaces.
